(19) United States
(12) Patent Application Publication
(10) Pub. No.: US 2005/0235267 A1
(43) Pub. Date: Oct. 20, 2005

(54) Method and system for capturing critical computer-intensive work-related data at the optimal time and with maximum accuracy

(76) Inventor: Peter McClard, Maplewood, NJ (US)

Correspondence Address: ARTHUR I DEGENHOLTZ, 32 VANDELINDA AVE, TEANECK, NJ, 07666, US

(21) Appl. No.: 10/827,833

(22) Filed: Apr. 20, 2004

(51) Int. Cl. G06F 9/44

(52) U.S. Cl. 717/127

(57) ABSTRACT

A method and system is provided for collecting computer-based and non computer-based work-related information in a convenient and accurate way and at the optimal time, when the work has just been completed.

### RELATED APPLICATIONS

This application is based on my Provisional Patent Application titled Method for Capturing Critical Job-related Information Automatically filed on Apr. 21, 2003.

### TECHNICAL FIELD

The present invention relates to a computer method and system for collecting important information about work that is performed on a computer and elsewhere, more particularly, to a method and system which automates and enhances the process of collecting work-related information.

### BACKGROUND OF THE INVENTION

There is an ever-increasing dependence on computers in the workplace. Computers are used to perform all manner of work-related tasks from Word Processing, to CAD for Engineering and Architecture, to Video and Film Editing, to Publishing of everything from advertisements to books and magazines, to Accounting, to Research, to Audio Production, to Project Management. Much work is also performed in browsers, whether it research, accounting, management or any of a myriad on-line applications (ASP).

Not surprisingly, computers are also used to record and track the work that is done on computers and elsewhere. However, invariably, these efforts and methods simply emulate what has been done on paper for centuries, the recording of a basic timesheet based on user recollection. In other words, present day time and activity tracking software requires users to input times and activities manually. This software comes in many forms from: full-fledged time and accounting software, to browser-based time entry, to custom in-house software. Some software provides timers that the user starts and stops like a virtual stopwatch. Some software is integrated into a larger management system where users are required to “check in” and “check out.” Some software provides a virtual timesheet which is to be regularly filled in by the user. Some software provides combinations of the above.

All of these software types require the user to be disciplined, to be precise and to be honest in order that the information gathered is of real value and to be trusted as a true reflection of the actual work performed. This has always been the case even with traditional paper timesheets. Most organizations have some way of either verifying the information provided thusly and approving it as a matter of record. However, even in the most stringent cases, there is a modicum of uncertainty because the information is almost without exception vulnerable to error for the following reasons: inaccurate recollection, procrastination, hurriedness and dishonesty.

Many efforts have been made to automate the process and or use machines to track the time and activities of workers. Punch cards are commonly used in industrial settings and require workers to “punch in” and “punch out” so that managers have a record of time and attendance. Computer-based punch card systems simply replace the paper ones with a screen and a keyboard but gather the same in-out information. While this may provide a general idea of when a worker started and ended work on a given day or went to lunch, is says nothing about what was done between those times.

These efforts have been greatly expanded when it comes to the modern, computer-based workflows that are mentioned above (i.e. Word Processing, CAD, etc.). There is a strong effort made to get a good record and use that record, but very little has been done to take advantage of the fact that the work being performed is on a computer and can thus be tracked by a computer in an intelligent and convenient manner.

Tracking activity on a computer automatically is not a new idea. Banks and other institutions have been doing it for years, especially ones where work is done in terminals and the computer is actually a main frame. A time stamp is attached to every such activity. There are a host of computer programs referred to as “spyware” which run in the background (often unbeknownst to the user) and “watch” what users do: which applications they use for how long, which documents they work on for how long, which URL they browse to for how long, which game they play for how long, etc. This data is then gathered and analyzed and can in fact provide a scientific record of gross computer activity that has value.

However, it has limited use for the following reasons: time spent in an application does not describe what was done. For example if it is a word processor that was open from 8:00 AM to 5:00 PM, how many documents were created, for what purpose or what clients were served. Were they corrections? Were they new letters, were they articles, and were they personal or business? If the software could tell the name of the document as some can based on the Window Title, then there would still be the problem of what the purpose of the document is, what work was done on it and which client it was for, what its status is and or what billing code should be assigned to it. Some companies have overcome some of these limitations by adopting a strict Naming Convention whereby the document name provided additional information to aid in the post-analysis of what can be a sea of data. Here again, user discipline is required to make sure documents are named properly and in the end, a name can only tell so much and still lacks many attributes such as: what was done, what's its status and any comments or Meta Data (data about the document) that might be pertinent.

There is no present day prior art solution that is adequate in accuracy, convenience and ability to provide useful, time-optimized information when it comes to automated time and activity tracking of computer-based work.

### OBJECTS AND SUMMARY OF THE INVENTION

It is an object of the present invention to provide a system and method for capturing critical computer-intensive work related data in an accurate and efficient manner.

Another object of the present invention to provide a system and method for capturing critical computer-intensive work related data without interfering with normal computer operation and with minimal intrusion upon computer users.

The foregoing and other objects and advantages of the present invention will appear more clearly hereinafter.

In accordance with the present invention there is provided a method and system for collecting computer-based and non computer-based work-related information in a convenient and accurate way and at the optimal time, when the work has just been completed.

The system according to the present invention includes two major sub-systems:
1. The Capture Sub-System which is used to gather time-optimized business data as herein described. The Capture Sub-System may run on any normal computer and operating system which would be used to perform work, including but not limited to desktop computers, laptop computers and any number of remote, handheld devices (e.g. Palm, Pocket PC, etc.)
2. The Manager Sub-System which is used to Manage aspects of the Capture Sub-System and the data that the Capture Sub-System produces as described herein. The Manager Sub-System may run on any normal computer and operating system and in order to perform properly when the data from two or more Capture Sub-Systems are to be combined a TCP/IP network connection is required, common to almost all modern computers. The Manager Sub-System consists of two components:
   a. The Manager Component for setting up preferences, creating installers and routing data to its final destination(s).
   b. The Antenna Component for handling all network interaction between the Manager Component and the Capture Sub-System(s).

This component can also be thought of and referred to as a Server.

Any work done in certain user-definable “tracked” software applications (e.g. Microsoft Word, Adobe Acrobat, MacroMedia Flash, etc.) or within certain selected URLS or domains is timed automatically and at the time of closing of such tracked documents or the tracked URL or domain, a dialog box is presented to the user showing them the exact time they spent (as an optional display). Also, an arbitrary number of additional options are presented such as a rounded-up version of the time based on user-defined billing increments or pop-up menus allowing the user to assign the work to a given job or project number, add details regarding the nature of the work done or to choose a category for the work to give the time information much more context and meaning. The exact content or layout of the dialog is incidental to the invention herein described. The fact that the dialog appears at the time it does and regardless of the application that was being used is a unique, central technology of this invention. We refer to this moment as time-optimized, because it is the time when knowledge of the work just performed is freshest and most accurate. This apparently simple achievement is actually quite complicated because it requires all non-document windows such as dialogs and palettes to be ignored when they are routinely closed and for the dialog to appear only when a “real” document has been closed. This is further complicated by the fact that each software manufacturer uses different window types and methods for representing documents. This has been overcome by utilizing a system of minimal user-defined parameters and/or modular plug-ins whereby a given manufacturer's peculiarities can be “filtered” out and the real document is discerned and tracked from opening to close. The plug-in filter is not always needed when certain standard practices are adhered to by the software manufacturer and whereby the needed information is available without a special filter. Further refinement to the system comes by excluding the “idle” time on a given document or URL. Idle time is determined in one of two ways: a) the document is no longer front most and is immediately put in idle mode (timer on pause) or b) the item is front most and the user has not interacted with it (i.e. clicked a mouse or pressed a key) for a user-definable amount of time (Idle Interval), usually five minutes.

The end goal of the present invention is to provide state-of-the-art, up-to-the-minute and accurate information for businesses and organizations to operate more efficiently. As such, the final product of the present invention is data. This data may be is finally stored using a range of devices and techniques. Once collected and completed, the data is deposited in the Master Database and is ready for further use.

### BRIEF DESCRIPTION OF THE DRAWINGS

Other important advantages of the invention will be apparent from the following detailed description taken in connection with the accompanying drawings in which:

FIG. 1 illustrates the method for determining the currently tracked document and adding new documents to the tracking list according to the present invention:

FIG. 2 illustrates the Master Tracking List;

FIG. 3 illustrates the method for determining if one of the currently tracked documents has been closed;

FIG. 4 illustrates the method to advance the timer for the currently tracked document;

FIG. 5 is an example of the Job Jacket Dialog for documents;

FIG. 6 is an example of the Job Jacket dialog for URLS and domains

FIG. 7 is an example of the Path Mapping dialog;

FIG. 8 is an example of the Name Mapping Dialog, and

FIG. 9 illustrates the system according to the present invention and illustrates the relationship between the Capture Sub-System and the Manager Sub-System.

### DETAILED DESCRIPTION OF THE INVENTION

The present invention provides a method and system for automatically and accurately timing work that is being performed on documents in user-specified applications on a computer and attaching to that work meaningful job-related data such as who it was done for and what exactly was done. The sum of the data collected is then stored in a database for analysis and or billing purposes. This replaces tedious manual methods that are currently used where timers are started and stopped and where the computer user is responsible for manually inputting this information, often grossly inaccurately.

There are two Classes of information which can be related to work performed on documents on a computer:
1. Document-related Information: That which is available automatically via the underlying computer system including, but not limited to: the time the document was opened and closed, how much time was spent working on the document, mouse and keyboard activity, the document's file location, what application is used, which computer is used, the document's name, the date, etc.
2. Job-related Information: That which must be input by a user or gathered by additional means of automation including, but not limited to: client, project, job number, status of the document, activity performed, billing status (e.g. billable, non-billable), billing category (e.g. corrections, proofreading, etc.), user name, user time input, user comment, etc.

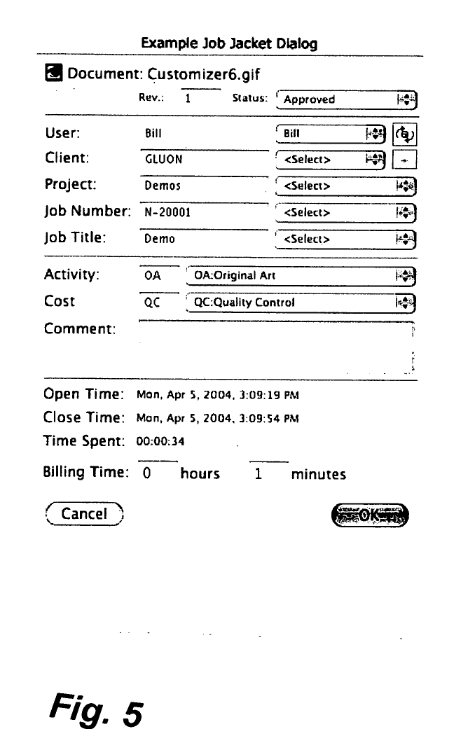

The present invention is intended to gather and unify both Classes of information in the most convenient way possible by presenting a Job Jacket Dialog Window as is shown in FIG. 5 at the close (or optionally upon the opening) of a computer-based document. This dialog is merely a facade of the underlying computer program and can be programmed to show any subset of the automatically gathered information from Class 1 above. However, the primary reason for showing the dialog is to allow the user to enter information from Class 2 above, which can't be automatically gathered (except with special additional methods which will be explained below). This additional information is then combined with the Class 1 information to create a Job Log entry, which is then posted to the database.

In order to achieve the automated timing of work done on computer-based documents and to bring up Job Jacket dialogs upon the closing of such documents, the most important thing is to first determine whether a given window displayed on a computer in fact represents a document. Since windows are used on computer to display all possible information that the user needs to see and interact with, they come in many forms and for many purposes. Windows themselves are nothing more than specialized containers into which programs pour content that needs to be displayed to the user viewing the window on a computer monitor. Rather than list all possible types of windows that might appear on a computer, let us divide them into three basic classes:
1. Documents: Those windows that represent a work product such as text that is being edited, pictures that are being worked on, diagrams, plans, spreadsheets, etc.
2. Document Views: Windows that represent supplemental views of work product documents. Many graphic programs allow such views. For example the user may be working on a picture of a car and want to retouch the tail light so may create a new view at 500% for close-up work on the light while still being able to see the full car and the result of the changes to the tail light in the original 100% view.
3. Dialogs, Palettes and other non-document windows: Those windows that are used to enter parameters, display information, control programs or the computer itself but don't contain a work product.

Since nearly all types of windows are opened when needed and closed when no longer needed or when the task is completed, it is crucial that the present invention is able to distinguish between documents and non-documents, because it would not be appropriate to show a Job Jacket Dialog just because the user has closed a palette or a dialog while working on a document (e.g. setting some paragraph formatting attributes in a word processor) or, for that matter, an alternate view of the document.

The method of the present invention cannot wait until a window is closed to make the determination as to whether a window qualifies as a document. This determination must be made upon window opening so that the opening time can be recorded and the work performed on the document can be accurately timed.

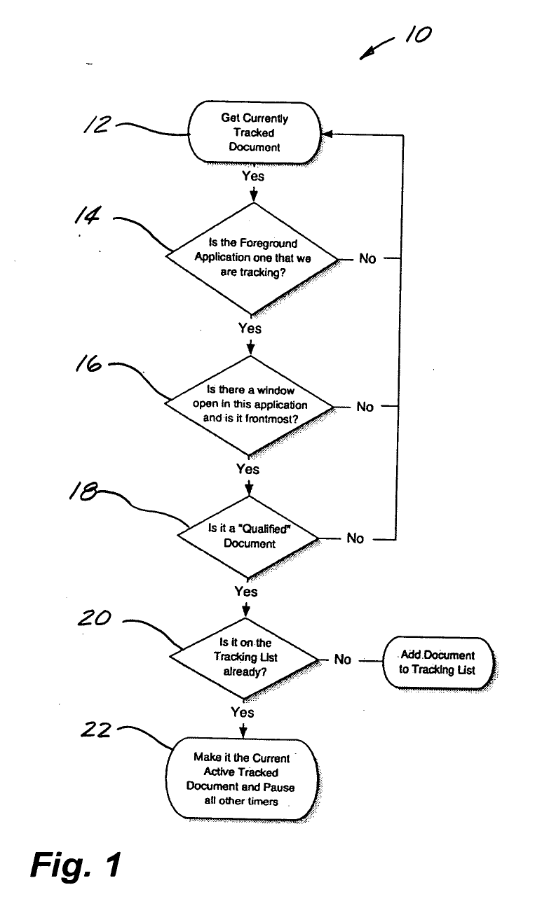

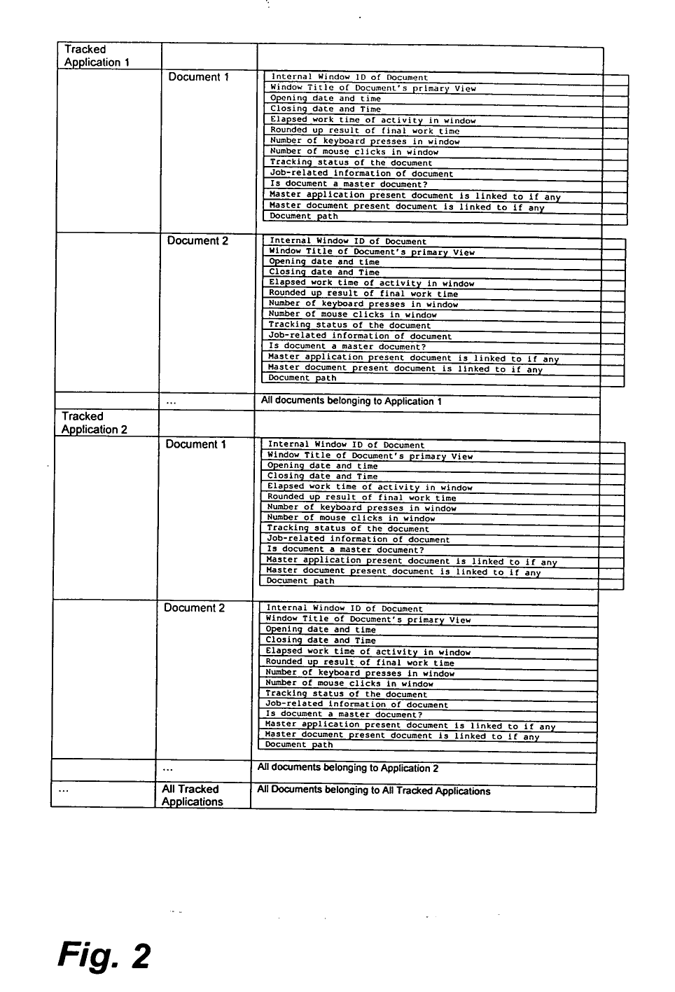

FIG. 1 illustrates the system and method 10 that is required to properly add documents to a Master Tracking List which is shown in FIG. 2. It is necessary to maintain a running list of all tracked applications (and their respective documents) which can be updated continually with time and other information as time moves forward, documents are opened, closed and switched in and out.

The following loop is run on a continual basis in the background and during times when the CPU is relatively free (which is most of the time with modern computers in normal working mode):

First we are given by the operating system the current active (front) application 12.

Then we compare this application to a user-defined list of Applications to Be Tracked 14. If it is not on the list, it is ignored and we return to the beginning of the loop.

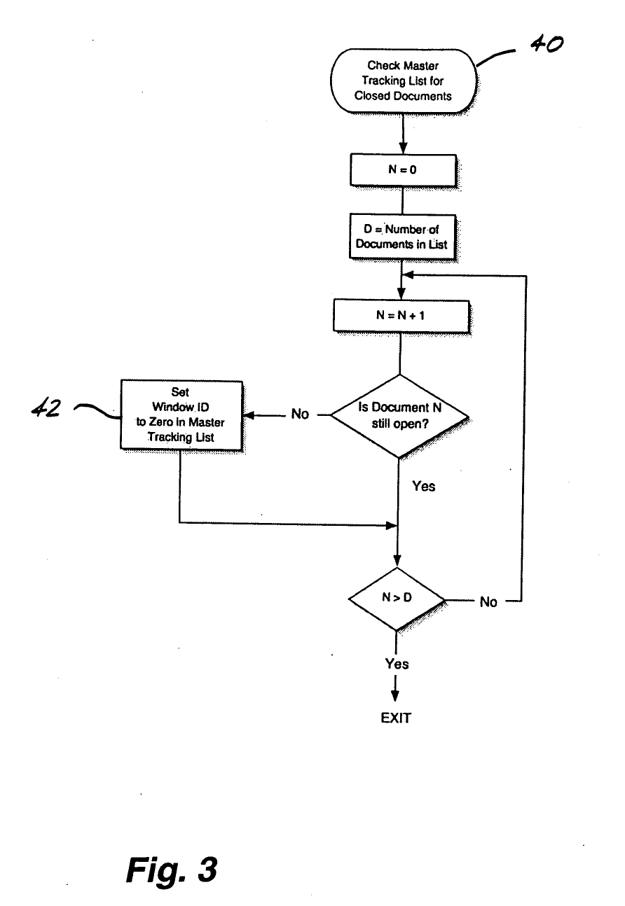

If it is on the list we then ask the system 10 for a list of all windows open in this application 16. If there are none open we return to the beginning of the loop. During this iteration we also check to see if a window that was on the Master Tracking List is no longer present (FIG. 3). If this is the case, the Window ID for the tracked document is set to NULL in the Master Tracking List which will precipitate a Job Log Event when the present loop is completed (described below).

For the current front application, an iteration loop of all documents listed in the Master Tracking list is performed. For each of these, the listed Window ID is compared to a list of ALL open windows for the application. If a match is not made, it is assumed the window has been closed and it's Window ID is set to zero in the list.

If there is a window open and it is front most we proceed to test the window to see if it qualifies as a document window 18.

Unqualified windows are palettes, dialogs and additional views (which can only come into existence after the original document has been opened).

The present invention qualifies document windows in one of several ways, including but not limited to:
1. Checking the title of the window, which may conform to predictable rules, which would immediately qualify it as a document. In an obvious example the title may contain “Docname.pdf” which in almost all cases would correspond to an Adobe Acrobat PDF. These rules are not hard to discern upon opening a number of different documents in some computer operating systems, but not all.
2. Checking the underlying internal window class id against that of the known internal window class id for documents in the given application.
3. Further qualifications such as scroll bars and other such controls on a window may mark it as a document for a given application.

The particular qualifiers for a given application's documents can be encoded into the present invention in two ways:
1. By use of a user defined table of known document attributes for a given application including known extensions (i.e. .pdf, .doc, .rtf, .gif) etc., known title delimiters such as “[”, “@”, etc., and the default name given to “Untitled” documents in the given application.
2. By use of an application plug-in (add-on) used by the present invention which passes known information such as title and other window information to the plug-in for that application which then compares the passed information to the information embodied in the plug-in, returning to the application the qualification of the document.

No single method can be used for all application because there can be exceptions and the plug-in method is required to screen using additional criteria for qualifying/disqualifying documents which the user-defined method can't detect. For instance there might be a window opened by an application which appears to be a document but is really just to show the user a news update and that window should not be tracked.

If the window fails to qualify as a document window it is skipped and we return to the beginning of the loop.

Once qualified as a document window, the process continues by checking to see if it has already been added to the Master Tracking List 20.

If it has not been added, it is now added, making it the Active Tracked Document, of which there is always one.

If it is already on the list then it is made the Active Tracked Document 22 and it's timer is made active, unless Idle mode has been entered 9as described below) and all other timers are paused (no longer advancing). In the Master Tracking List, each document has a record which represents the Elapsed Work Time on the document, which is independent of the Elapsed Open Time.

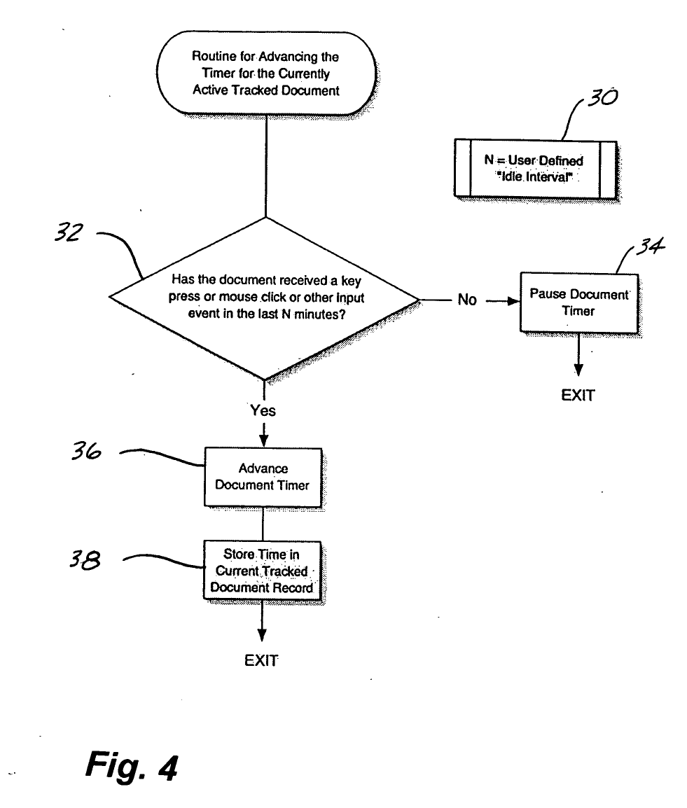

FIG. 4 illustrates how the method according to the present invention determines and updates the Elapsed Work Time. The user is able to establish an Idle Time Interval which is defined in FIG. 4 by the capital letter N and the reference numeral 30.

If a user is not interacting with a computer, i.e. using the computer keyboard or mouse to affect the content of the document or otherwise navigate the document, then the present invention considers the computer to be in Idle Mode, if the Idle Mode Period exceeds the user-defined Idle Time Interval, as indicated by block 32 the timer for the document is not advanced 34.

However, if the user has interacted in any way with the document within the user-defined Idle Time Interval, the Idle Mode Period is set to zero and the Elapsed Work Time is advanced 36. The elapsed time is stored in the Current Tracked Document Record 38.

The Idle Mode Period is a global variable that applies to all open documents and is not stored separately per document.

In a concurrent variation of the above loop, using the exact same methods except in the source of the Window Information which is now substituted with URL information, the present invention is able to gather an accurate record of time spent viewing and interacting with particular URLs and domains in specific browser applications. Window title information becomes all but useless in the Internet case because the title can switch from one page to another and may have nothing to do with the actual location on the Internet which is being viewed (the URL). For example if a user had spent one hour viewing www.uspto.gov but had visited many web pages within that domain, the present invention can provide an accurate record of the total time spent working (Idle Time excluded) in the overall domain without providing details on individual pages visited and regardless of whether the user had many times over any period switched in and out of the browser to do other things or even quit the browser. Furthermore, this can be achieved on unlimited number of URLs or domains.

As a supplement to the URL and domain time tracking, the present invention provides a method whereby the user can pre-enter into a stored list a number of Domains or URLs of Interest. By checking browser activity against this list, the present invention is able to open a special Job Jacket Dialog upon finished usage of a Domain or URL of Interest.

FIG. 3 illustrates the method for determining if one of the currently tracked documents has been closed and includes: checking the Master Tracking List for closed documents 40 and setting the window ID to zero 42 if the document is closed.

Once the above loops, which are illustrated in FIGS. 1, 3 and 4, to add documents and/or URLs and domains and advance timers for those documents and/or URLs and domains, are completed a final test is made of the Master Tracking List. For any documents on the list which have had the Window ID set to NULL (zero) the data collected for that document is completed in one of three ways constituting a Job Log Event:
1. A Job Jacket Dialog is presented to the user as shown in FIG. 5 where the user adds job-related information.
2. The data is sent, as is, to the database
3. The data is combined with additional information based on information gathered and other user-defined settings or presets and sent to the database.

The present invention saves Job Logs in one of two places:
1. To a Master Database where it becomes a finalized Job Record.
2. To a local database where the user will have the possibility of deleting or further refining the Job Log such as assigning it to a particular client or project or even editing the time record (if permitted). Such Job Logs are referred to as Deferred Logs.

The present invention provides for multiple methods of deferring logs, which are governed by user-defined preferences, most often controlled by an Administrator. The current methods are:
1. Defer Automatically in which case all logs are deferred so the user will have maximum control over the finalized Job Record.
2. Deferred Temporarily by virtue of the fact the document that the Log represents is Attached to a Master Document that is still open (see below).
3. Deferred Temporarily by virtue of the fact that the connection to the Master Database is not available.
4. Defer Ad-hoc whereby the user will be given a button in the Job Jacket Dialog to allow them to keep the record locally rather than the default of sending to the Master Database.
5. Defer by Incompleteness whereby for any reason the Job Log is not sufficiently “filled in” to be added to the Master Database
6. Defer by Invalidity whereby the Job Log is deemed by given rules not to be valid or otherwise disqualified.

The present invention provides for a method whereby Deferred Logs can be edited, reassigned and completed and sent to the Master Database or deleted, whether singly or in batches.

The present invention provides a method whereby a tracked document can become a Master Document, which will serve as the provider of the class 2 (user input) information for all Attached Documents.

The present invention provides a method whereby any number of documents in a given application can become Attached to a Master Document in the same or another application. Such Attached Documents are able to forgo the Job Jacket Dialog and when closed produce an incomplete Deferred Log which is then completed when the Job Jacket for the Master Document is filled in, after which normal tracking behavior resumes.

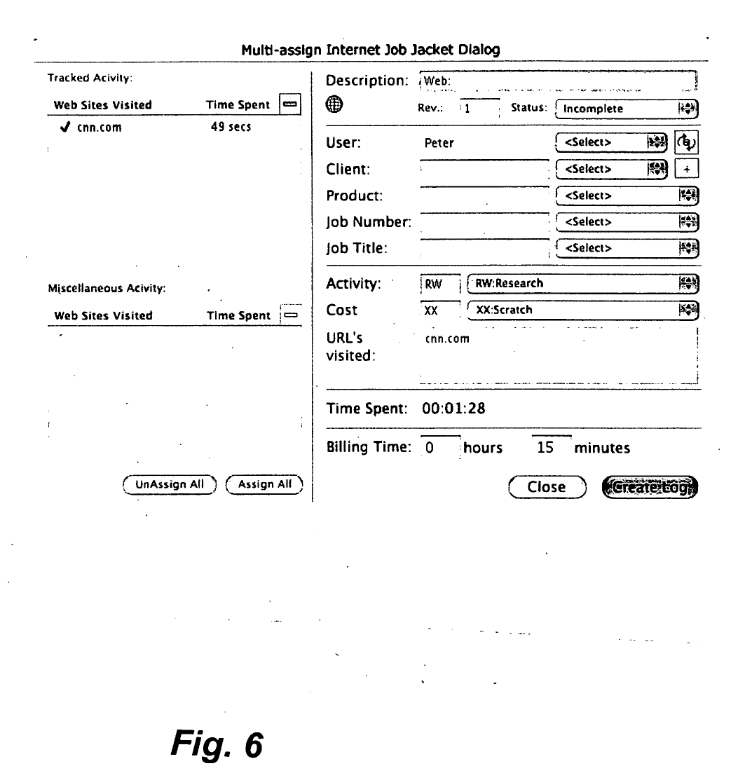

The present invention provides a method whereby work performed on specific URLs or domains in standard web browsers can be timed and this work later turned into Job Logs using a specialized Multi-assign Internet Usage Job Jacket Dialog (FIG. 6).

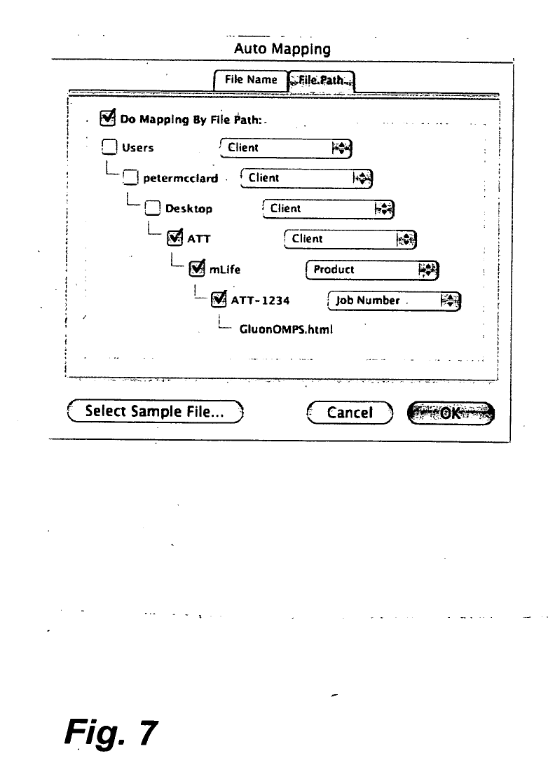

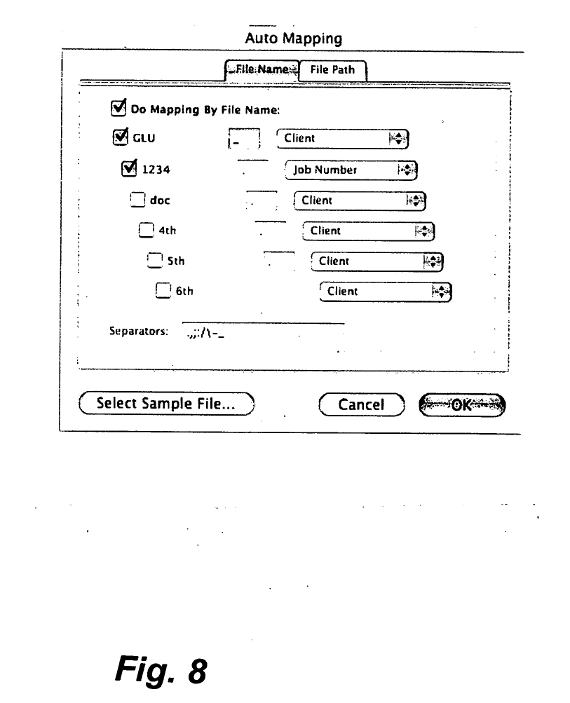

The present invention provides a method whereby if the user decides to forgo the Job Jacket Dialog option, certain other Class 2 information can still be added by virtue of two methods:
1. Document Path Analysis where the invention provides a way for the user to assign fixed meaning to different levels of the path. For example if the path were: C://Documents/Ford/Taurus/Brochure.pdf, working backwards from the document, the invention provides a means to set a Path Mapping to Class 2 categories (FIG. 7) so the Product could be set to Taurus and the Client could be set to Ford automatically because the Mapping had been pre-set to a stored list to be Level 1=Product and Level 2=Client.
2. Document Name Analysis where the invention provides a way for the user to assign fixed meaning to different segments of the document name. For example if the name were: FD_TRS_{—}1234_Brochure.pdf, the invention provides a means to set a Name Mapping to Class 2 categories (FIG. 8) so the Product could be set to TRS and the Client could be set to FD and the Job Number could be set to 1234 automatically because the Mapping had been pre-set to a stored list to be Segment 1=Client and Segment 2=Product and Segment 3=Job Number with the underscore character set as the delimiter.

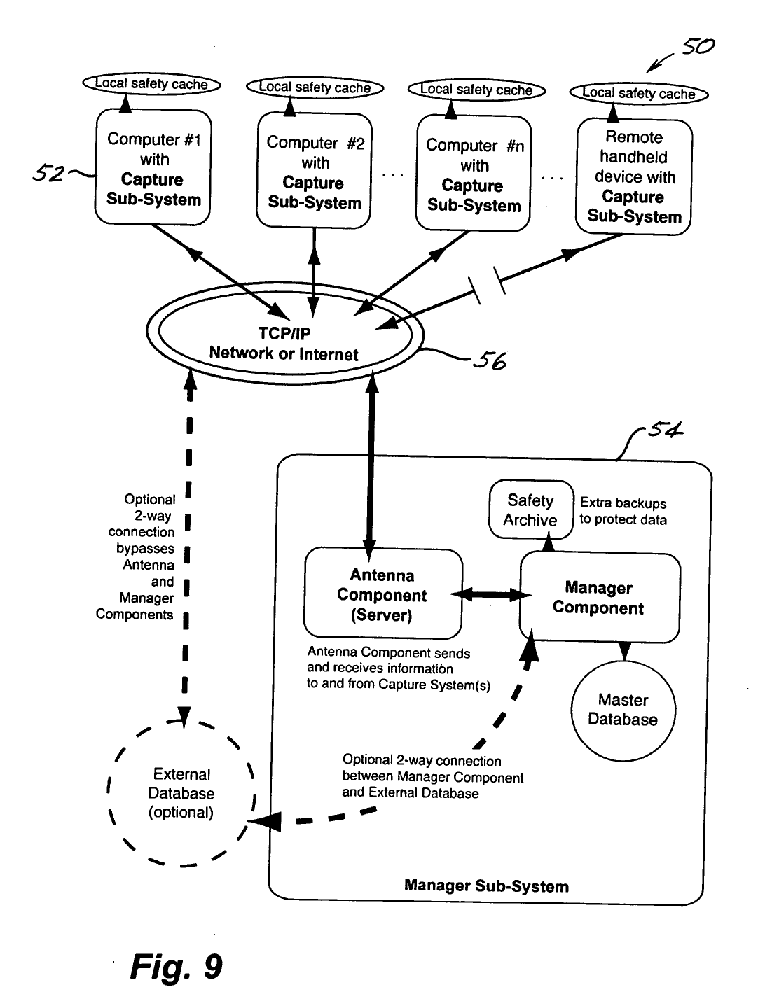

The system 50 according to the present invention includes a Capture Sub-System 52 and a Manger Sub-System 54 which are described with reference to FIG. 9 as follows:

The Capture Sub-System 52 is used to gather time-optimized business data as herein described. The Capture Sub-System may run on any normal computer and operating system which would be used to perform work, including but not limited to desktop computers, laptop computers and any number of remote, handheld devices (e.g. Palm, Pocket PC, etc.)

The Manager Sub-System 54 is used to Manage aspects of the Capture Sub-System and the data that the Capture Sub-System produces as described herein. The Manager Sub-System may run on any normal computer and operating system and in order to perform properly when the data from two or more Capture Sub-Systems are to be combined a TCP/IP network connection 56 is required, common to almost all modern computers.

The Manager Sub-System 54 consists of two components:
c. The Manager Component for setting up preferences, creating installers and routing data to its final destination(s).
d. The Antenna Component for handling all network interaction between the Manager Component and the Capture Sub-System(s).

This can also be thought of and referred to as a Server.

The purpose of the Capture Sub-System is to send its data to the Master Database via the Manager Sub-System or optionally to an External Database via special components tailored to the specific External Database.

The Manager Component of the Manager Sub-System is used to setup the preferences for the Capture Sub-System such as which applications to track, which Job Numbers to list in the Job Jacket and much more. In addition, the Manager Component is used to create special installers for the Capture Sub-System. These installers are used to disseminate the Capture Sub-System efficiently and correctly. In addition to these two crucial functions, the Manager Sub-System is also able to manage data that is sent from the Capture Sub-System, for example deposit it in the Master Database where it then becomes useful. The special needs of communication between the Capture Sub-System and the Manager Sub-System is handled by the Antenna Component. The Antenna Component is a separate, specialized entity in order to maximize the robustness of the System and Methods of the invention in the context of larger organizations, allowing seamless operation for multiple users, even though the Manager Component may not be in operation.

The Manager Sub-System and Method is described as follows:

The Manager Sub-System has four purposes:
1. To receive data (Job Logs) from the Capture Sub-System and deposit them in the Master Database
2. To send current data to the Capture Sub-System (current Clients, Job Numbers, Users, etc.).
3. To set preferences for the Capture Sub-System including but not limited to: How and when the Job Jackets will appear; what IP address the Capture Sub-System will communicate data to and from; what applications to track; what lists to populate menus in the Job Jackets with (e.g. Activity Codes, Cost Categories, Status, etc.); path and name mapping settings; etc.
4. To create installers for the Capture Sub-System which embody the settings above and facilitate dissemination of the Capture Sub-System

To achieve this with greatest efficiency and overall stability the Manager Sub-System is configured as two Components:
1. The Manager Component which performs the settings methods, creates the installers and deposits the final data in the Master Database
2. The Antenna Component which handles all network communication between the Capture Sub-System and the Manager sub-System. It passes data received from the Capture Sub-System to a place where the Manager Component can access it as needed. It also accesses data that has been set in the Manager Component such as new Job Numbers and relays that information to the Capture Sub-System upon demand.

The advantage of the dual component method is twofold:
1. A dedicated network component can operate in a simpler and less error-prone manner than one which embodies all functions of the Manager Sub-System.
2. The Manager Component can be running or not and communication is still maintained between the Manager Sub-System and the Capture Sub-System, allowing users to send logs and add new Job Numbers remotely.

The present invention provides one additional way for data to be transferred to and from the Capture Sub-System. This is achieved by a plug-in method to the Capture Sub-System itself whereby all data is sent and retrieved from and External Database via a protocol other than the ones provided by default. For instance, an organization may have an existing corporate database with Job Numbers and Time Billing information and thus would desire to skip the use of the Antenna Component and have the Capture Sub-System “talk” directly with the corporate database. In such cases, the Manager Component is still needed to set preferences and create installers.

The various specific embodiments of the present invention are for illustrative purposes only. Various changes and modifications may be made within the spirit and scope of the present invention.

1. A method for capturing job related information from the operation of selected software applications comprising:
a. detecting a selected software application open in the foreground of a computer screen;
b. determining if there is an open window in said software application;
c. determining if said open window represents a document;
d. stopping said timer responsive to the closing of said open window, and
e. recording elapsed time information generated by said timer.

2. The method according to claim 1 wherein said step c further comprises:
providing a list of documents, and
determining if said document associated with said open window appears on said list of documents.

3. The method according to claim 1 wherein, after step f, further comprising step of:
assigning a project number to said elapsed time data.

4. A system for capturing job related information from the operation of selected software applications comprising:
a filter for comparing selected information from a software application
to determine if a selected window in the application is a document.

5. A method for capturing job related information from the operation of selected software applications comprising:
detecting the opening of documents within said selected software application;
detecting the closing of documents within said selected software application;
presenting a dialog box responsive to the closing of documents within said selected software application, and
collecting time open, time closed and time worked on documents within documents within said selected software application.

6. The method according to claim 5 further comprising the step of:
excluding idle time from said time worked.

7. The method according to claim 5 wherein said selected software application comprises network domain usage.

8. The method according to claim 5 wherein said selected software application comprises selected URL usage.

9. The method according to claim 5 further comprising:
adding new selected software applications by entering selected parameters in a stored list of parameters.

10. A system comprising:
a master database;
a server connected to said master database;
a network connection;
a plurality of computers with each of said plurality of computers connected to said network connection and with each of said computers comprising:
means for detecting the opening of documents within a selected software application, detecting the closing of documents within said selected software application, presenting a dialog box responsive to the closing of documents within said selected software application, and collecting time open, time closed and time worked on documents within said selected software application.

11. The method according to claim 5 further comprising:
combining time open, time closed and time worked information with selected software related information,

12. The method according to claim 5 further comprising:
storing said time open, time closed and time worked information in a database.

13. The method according to claim 5 further comprising:
creating a job log.

14. The method according to claim 5 further comprising:
detecting a document within a selected software application open in the foreground of a computer screen utilizing a plug-in containing software specific information.
